(19) United States
(12) Patent Application Publication
(10) Pub. No.: US 2003/0101259 A1
(43) Pub. Date: May 29, 2003

(54) Method and system for updating data

(75) Inventor: Po-Wen Lu, Taipei (TW)

Correspondence Address: EDWARDS & ANGELL, LLP, P.O. BOX 9169, BOSTON, MA, 02209, US

(73) Assignee: Inventec Corporation, Taiwan, R.O.C.

(21) Appl. No.: 09/996,218

(22) Filed: Nov. 28, 2001

(51) Int. Cl. G06F 15/16; G06F 15/173

(52) U.S. Cl. 709/224; 709/203

(57) ABSTRACT

A method and a system for updating data are proposed, for allowing a user at a client's computer device to monitor data condition in a server, wherein the server includes a data-updating module and a data-reading module, and is pre-constructed with a database and a corresponding result table. First, when a data source transmits data to the server, the transmitted data are stored in the database. When a predetermined data-updating time is reached in operation of the server, the data-updating module retrieves the data from the database and stores the retrieved data in the result table. When a predetermined data-reading time is reached in operation of the client's computer device, a data-reading request is submitted to the server, allowing the data-reading module to read the data in the result table according to the request and transmit the read data to the client's computer device for display.

### FIELD OF THE INVENTION

The present invention relates to methods and systems for updating data, and more particularly, to a method and a system for updating data, allowing the load for updating data to be reduced in a server even in the condition of a plurality of users at client's computer devices monitoring operation of the server.

### BACKGROUND OF THE INVENTION

In client/server architecture, a server is used to store a large amount of data for allowing a client to access the data. Such client/server architecture is advantageous to be cost-effective for data maintenance, updating and transmission.

For example, world wide web (WWW) typically employs client/server architecture, in which a web host has a server for listening to a TCP port 80 and waiting for a connection request from a client. After establishing a connection of the client to the server, the client sends a request and the server releases a corresponding response. However, when the server simultaneously processes requests from a plurality of clients, this then increases the load of the server. For example, in the case of N clients in the client/server architecture, if the clients each sends a request to the server in every minute, then the server needs to make 60×N responses in an hour.

FIG. 1 illustrates architecture for data transmission between a plurality of client's computer devices 2 and a server 1, wherein an agent server 3 is incorporated between the server 1 and the client's computer devices 2. In the agent server 3 there is constructed an agent program for processing a data-reading request generated from the agent server 3 to the server 1, so as to allow the agent server 3 to monitor the data or data change in the server 1 in real time. Moreover, the agent server 3 employs an application programming interface (API) for supporting transmission protocol of TCP/IP or UDP (user data protocol), in which the agent server 3 can recognize addresses of the server 1 and the client's computer devices 2. Therefore, when the client's computer devices 2 each proposes a request for updating data to the server 1 in every minute, the agent server 3 processes the requests in a manner as to send one request per minute to the server 1, and obtains updated data after the server 1 completes the data updating process so as to transfer the corresponding updated data to each of the client's computer devices 2 according to its IP address. In this case, the server 1 merely needs to execute 60 times of response in an hour.

As mentioned above, the architecture shown in FIG. 1 can significantly reduce load of the server 1, however, the cost is increased due to additionally provision of the agent server 3 Moreover, the client's computer devices 2 each is constructed with the API for establishing data transmission protocol with the agent server 3, so that complexity of the architecture is increased.

Therefore, it is desired to develop a method and a system for updating data, which are advantageous in reducing load of a server, decreasing the system cost and shortening system construction time, in an effort to optimize data transmission.

### SUMMARY OF THE INVENTION

The primary objective of the present invention is to provide a method and a system for updating data, in which load of a server is not increased, the system complexity is decreased, as well as system development time and cost are reduced, in the condition of a plurality of client's computer devices in connection to the server.

A method for updating data proposed in the invention is applied to a system for updating data for allowing a user at a client's computer device to monitor data condition in a server, wherein the server is preconstructed with a database having a plurality of data fields for storing data transmitted from a data source therein, and with a result table corresponding to the data fields.

The method for updating data comprises the steps of (1) storing via the server the data transmitted from the data source in the data fields of the database; (2) retrieving via a data-updating module of the server the data from the data fields of the database, and storing the retrieved data in data fields of the result table corresponding to the data fields of the database, when a predetermined data-updating time being reached in operation of the server; (3) submitting via the client's computer device a data-reading request to a server, when a predetermined data-reading time being reached in operation of the client's computer device; (4) reading the data in the result table via a data-reading module of the server according to the data-reading request after receiving the data-reading request via the server; (5) transmitting the read data from the result table via the data-reading module of the server to the client's computer device which submits the data-reading request; and (6) displaying the data transmitted from the result table on a screen of the client's computer device to be monitored by the user.

The system for updating data of the invention comprises at least one server; a plurality of client's computer devices respectively connected to the server by a network; and a data source connected to the server by a network, for transmitting data to the server. The server comprises a database having a plurality of data fields for storing the data transmitted from the data source therein; a result table having a plurality of data fields corresponding to those of the database; a data-updating module for retrieving the data from the data fields of the database and storing the retrieved data in the corresponding data fields of the result table so as to update the data in the result table, when a predetermined data-updating time being reached in operation of the server; and a data-reading module for receiving a data-reading request from one of the client's computer devices and retrieving the data from the data fields of the result table so as to transmit the retrieved data to the client's computer device, when a predetermined data-reading time point being reached in operation of the client's computer device.

### BRIEF DESCRIPTION OF THE DRAWINGS

The present invention may best be understood through the following description with reference to the accompanying drawings, in which:

FIG. 1 (PRIOR ART) is a schematic network diagram showing a conventional method for updating data in the use of client/server architecture;

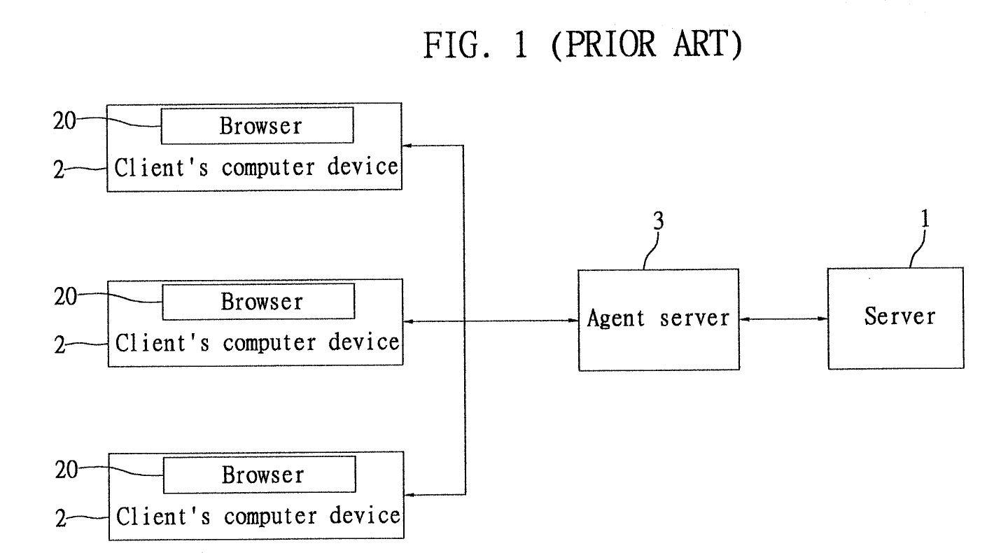

FIG. 2 is a schematic system diagram showing a first preferred embodiment of the system for updating data of the invention;

FIG. 3 is a schematic diagram showing the steps involved in performing a first preferred embodiment of the method for updating data of the invention;

FIG. 4 is a schematic diagram showing interaction between a client's computer device and a server in the steps of FIG. 3;

FIG. 5 is a schematic system diagram showing a second preferred embodiment of the system for updating data of the invention; and

FIG. 6 is a block diagram showing a program for updating data of FIG. 5.

### DETAILED DESCRIPTION OF THE PREFERRED EMBODIMENT

First Preferred Embodiment

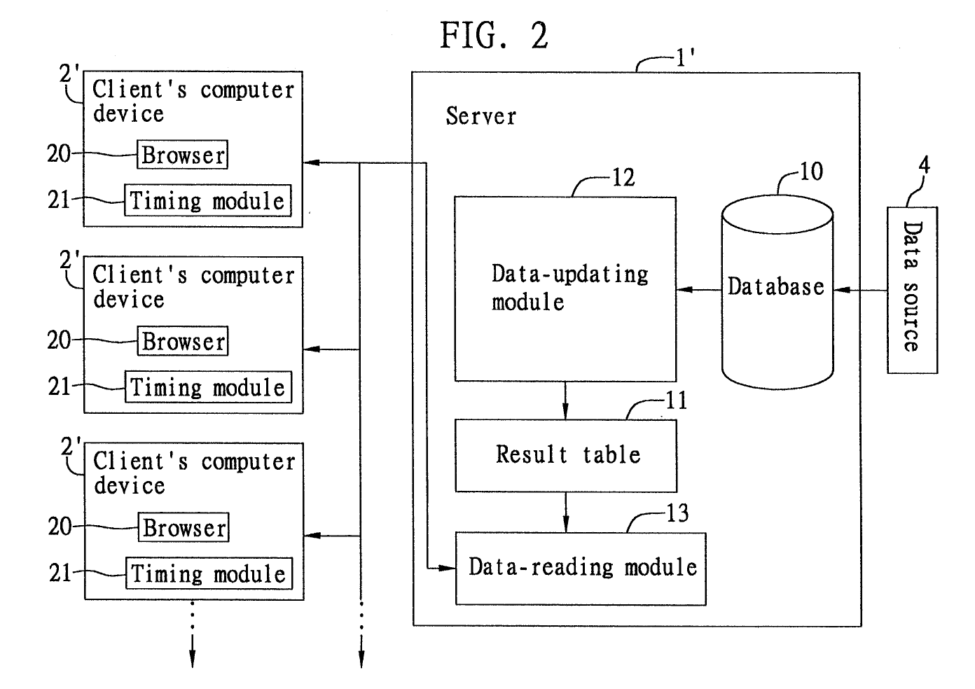

FIG. 2 illustrates a first preferred embodiment of the system for updating data of the invention. As shown, the system for updating data comprises at least one server 1′, a plurality of client's computer devices 2′, and a data source 4, wherein the client's computer devices 2′ and the data source 4 are respectively connected to the server 1′ via a network (not shown). In practical application, for example, the data source 4 can include information of a production plan constructed by a manufacturing department and transmit the production plan to the server 1′. In such a condition, the server 1′ can be a host for storing the production plan, while the client's computer devices 2′ each is a production terminal device connected to the server 1′ for reading the production plan stored in the server 1′ in real time, so as to perform production according to the production plan.

The client's computer device 2′ each includes a browser 20 and a timing module 21, in which the browser 20 is connected to the server 1′ via a network (e.g. Internet, not shown) for retrieving data stored in the server 1′ and displaying the data on a screen (not shown) of the client's computer device 2′. The timing module 21 is used for counting time required for the client's computer device 2′ to propose a data-reading request to the server 1′. When the counted time reaches a predetermined time, the data-reading request generated by the client's computer device 2 is submitted to the server 1′.

The server 1′ includes a database 10, a result table 11, a data-updating module 12 and a data-reading module 13. The database 10 is used for storing data transmitted from the data source 4. The result table 11 is constructed in a manner as to have a plurality of data fields corresponding to those of the database 10. In the case of the server 1′ reaching a predetermined data-updating time point, the data-updating module 12 stores data of the database 10 in the result table 11. Therefore, when the server 1′ receives a data-reading request from a client's computer device 2′, the data-reading module 13 retrieves the data from the result table 11 and transfers the data to the client's computer device 2′ according to the data-reading request.

As such, in the condition of a plurality of the client's computer devices 2′ proposing data-reading requests to the server 1′ at a time, the server 1′ only needs to transmit the data stored in the result table 11 to the client's computer devices 2′. That is, in the method and system for updating data of the invention, data are pre-processed for updating if necessary and stored in the result table 11, so as to allow the client's computer device 2′ to read the data in real time, and thereby reduce load of the server 1′ in processing the data-reading requests.

Additionally, the timing module 21 of the client's computer device 2′ can also be provided in the server 1′ (not shown in this embodiment), for counting time required for the server 1′ to transmit the data stored in the result table 11 to the client's computer device 2′. When the counted time reaches a predetermined data-transmitting time, the server 1′ automatically transmits the data to the client's computer device 2′.

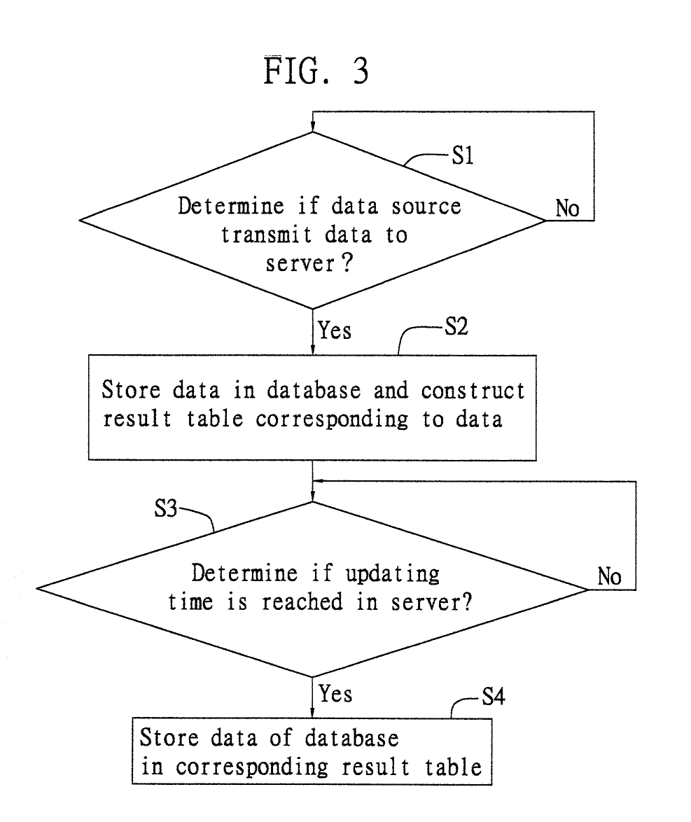

FIG. 3 illustrates the steps involved in performing a preferred embodiment of FIG. 2, for depicting interaction between the server 1′ and the data source 4.

First in step S1, the data source 4 is determined if transmitting data to the server 1′. If the data source 4 transmits the data, then step S2 is followed, or else, the step S1 is repeated.

In step S2, the server 1′ stores the data transmitted from the data source 4 in the data fields of the database 10 and creates the result table 11 corresponding to the transmitted data. Thereafter, step S3 is followed.

In step S3, the server 1′ is determined if reaching a data-updating time. If the data-updating time is reached, then step S4 is followed, or else, the step S3 is repeated.

In step S4, the data-updating module 12 stores the data from the data fields of the database 10 in the corresponding data fields of the result table 11.

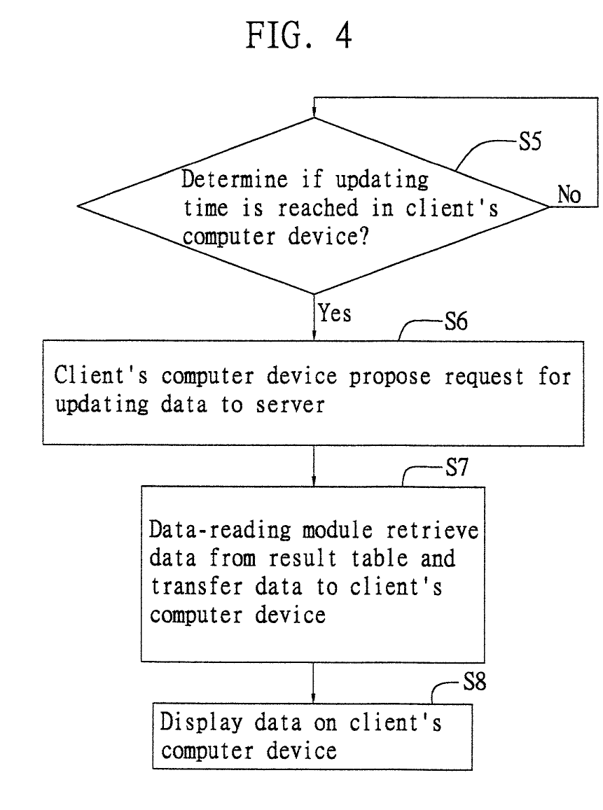

FIG. 4 illustrates interaction between the server 1′ and the client's computer device 2′ in the steps of FIG. 3.

First in step S5, the client's computer device 2′ is determined if reaching a data-updating time. If the data-updating time is reached, then step S6 is followed, or else, the step S5 is repeated.

In step S6, the client's computer device 2′ submits a data-reading request to the server 1′. Thereafter, step S7 is followed.

In step S7, after receiving the data-reading request from the client's computer device 2′, the server 1′ employs the data-reading module 13 thereof to retrieve the data in the result table 11 and transmit the data to the client's computer device 2′. Thereafter, step S8 is followed.

In step S8, the client's computer device 2′ displays the data transmitted from the server 1′ on a screen thereof (not shown).

In view of the method and system for updating data in the above first embodiment of the invention, as data are pre-processed for updating if necessary and stored in the result table 11, the server 1′ only needs to transmit the data stored in the result table 11 to the client's computer devices 2′ according to the data-reading requests from the client's computer devices 2′, so that load of the server 1′ in processing the data-reading requests can be significantly reduced.

Second Preferred Embodiment

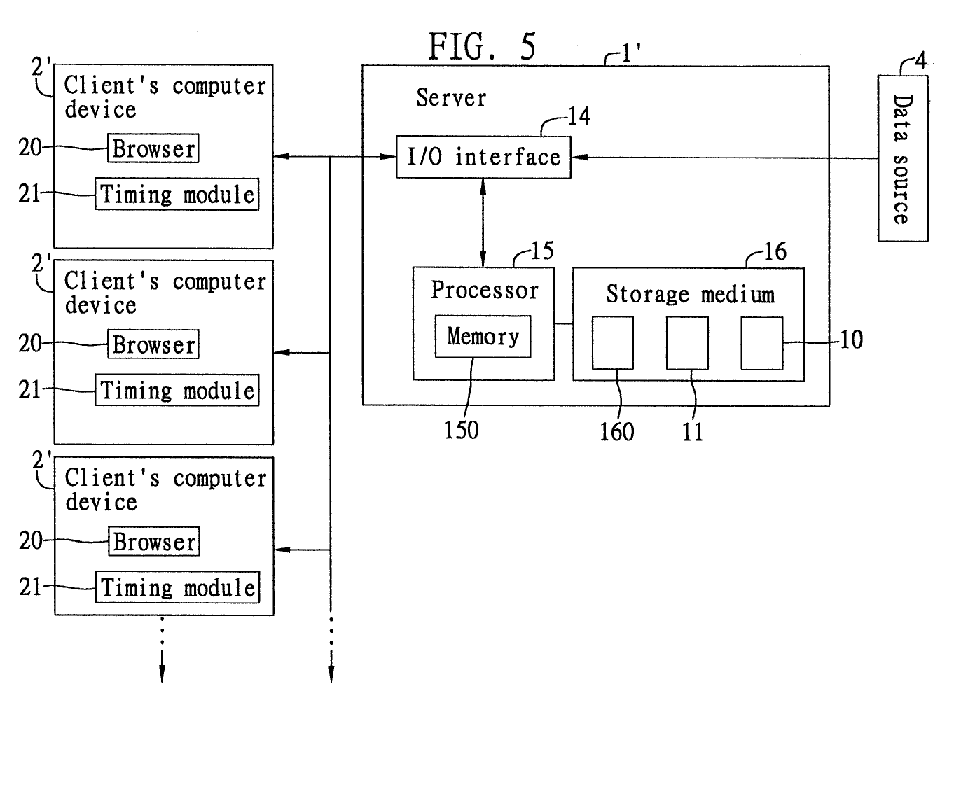

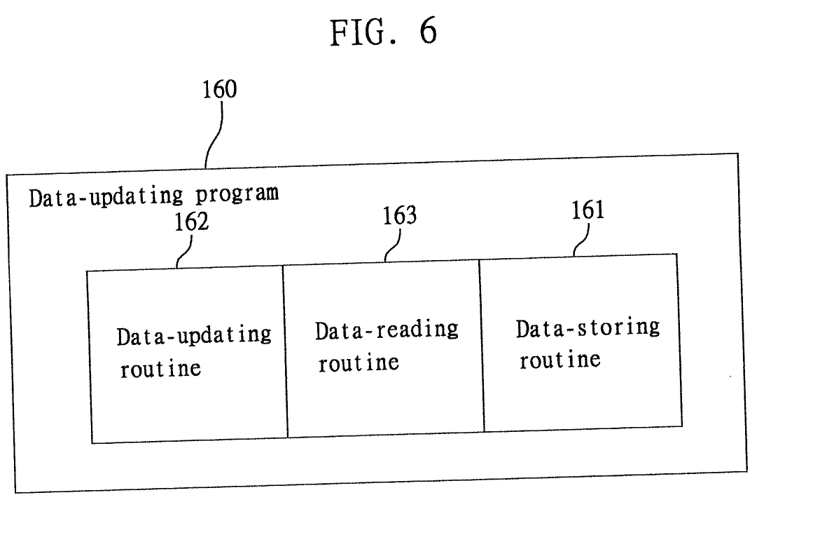

FIG. 5 illustrates a second preferred embodiment of the system for updating data of the invention; FIG. 6 illustrates a data-updating program for use in the second preferred embodiment. As shown in FIGS. 5 and 6, the system for updating data of the second embodiment is constructed in a server 1′ including an I/O interface 14, a processor 15 having a memory 150, and a storage medium 16. The storage medium 16 includes a data-updating program 160, a foregoing result table 11 and a database 10.

The processor 15 can execute the data-updating program 160 for performing tasks of the foregoing data-updating module 12 and data-reading module 13, such as storing data of the database 10 in the result table 11, and retrieving the data from the result table 11, respectively. In the program execution, all data transmission and reception are performed through the I/O interface 14. As shown in FIG. 6, the data-updating program 160 contains a data-storing routing 161, a data-updating routine 162 and a data-reading routine 163. In this embodiment, the data-updating program 160 is stored in the storage medium 16; alternatively, it is to be understood that the data-updating program 160 can also be stored in a ROM of the processor 15, such as MASK ROM, EPROM, or EEPROM, if the data-updating program 160 is not over-sized.

In addition, the processor 15 can be a microprocessor or a CPU. The memory 150 can be a DRAM. The storage medium 16 can be a hard disk, a tape, or a compact disk. The database 10 is provided with data transmitted from the data source 4 as above depicted. The result table 11 includes updated data generated by the foregoing data-updating module 12 processing the data in the database 10.

The method for updating data for use with the system for updating data in FIG. 5 is depicted in detail by the following description for the data-storing routing 161, the data-updating routine 162 and the data-reading routine 163.

Referring to FIG. 6, after establishing the network connection between the server 1′ and data source 4, the data-storing routing 161 allows the data source 4 to transmit data to the server 1′, and constructs the result table 11 corresponding to the transmitted data. Moreover, the data-storing routing 161 is also used to temporarily store a data-updating time in the memory 150 of the processor 15, allowing the processor 15 to determine if the server 1′ in operation reaches the data-updating time. If the data-updating time is reached, the data-updating routing 162 is executed for retrieving the data from the database 10 and storing the retrieved data in corresponding data fields in the result table 11.

After updating the data stored in the result table 11, when the server 1′ receives a data-reading request from a client's computer device 2′, the data-reading routine 163 reads the data in the result table 11 and transmits the read data to the client's computer device 2′.

As shown in FIG. 5, although the data-updating program 160 is stored as software in the storage medium 16, it should be noted that the data-updating program 160 can also be stored in hardware such as integrated circuit to cooperate with the processor 15.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A method for updating data, being applied to a system for updating data for allowing a user at a client's computer device to monitor data condition in a server, wherein the server is pre-constructed with a database having a plurality of data fields for storing data transmitted from a data source therein, and with a result table corresponding to the data fields; the method comprising the steps of:
(1) setting a predetermined data-updating time via the system for updating data, wherein the server retrieves the data from the data fields of the database and stores the retrieved data in data fields of the result table corresponding to the data fields of the database, when the predetermined data-updating time is reached in operation of the server; and
(2) setting a predetermined data-reading time via the system for updating data, wherein the client's computer device submits a data-reading request the server for allowing the server to retrieve the data from the data fields of the result table according to the request and transmit the retrieved data to the client's computer device, when the predetermined data-reading time is reached in operation of the client's computer device.

2. The method of claim 1, wherein the system for updating data is constructed in a manner that at least one server is connected to a plurality of client's computer devices.

3. The method of claim 2, wherein the server is connected to the data source by a network.

4. The method of claim 3, wherein the computer includes a browser for allowing the user to submit the data-reading request so as to monitor the data condition in the server.

5. The method of claim 1, wherein the server comprises:
the database;
the result table;
a data-updating module for storing the data in the data fields of the result table as set forth in the step (1); and
a data-reading module for retrieving the data from the result table and transmitting the retrieved data to the client's computer device as set forth in the step (2).

6. The method of claim 5, wherein the server further comprises a timing module for counting time required for the server to store the data in the result table and comparing the counted time with the predetermined data-updating time as set forth in the step (1).

7. The method of claim 1, wherein the client's computer device further comprises a timing module for counting time required for the client's computer device to submit the data-reading request and comparing the counted time with the predetermined data-reading time as set forth in the step (2).

8. A method for updating data, being applied to a system for updating data for allowing a user at a client's computer device to monitor data condition in a server, wherein the server is pre-constructed with a database having a plurality of data fields for storing data transmitted from a data source therein, and with a result table corresponding to the data fields; the method comprising the steps of:
(1) storing via the server the data transmitted from the data source in the data fields of the database;
(2) retrieving via a data-updating module of the server the data from the data fields of the database, and storing the retrieved data in data fields of the result table corresponding to the data fields of the database, when a predetermined data-updating time being reached in operation of the server;
(3) submitting via the client's computer device a data-reading request to a server, when a predetermined data-reading time being reached in operation of the client's computer device;
(4) reading the data in the result table via a data-reading module of the server according to the data-reading request after receiving the data-reading request via the server;
(5) transmitting the read data from the result table via the data-reading module of the server to the client's computer device which submits the data-reading request; and
(6) displaying the data transmitted from the result table on a screen of the client's computer device to be monitored by the user.

9. The method of claim 8, wherein the system for updating data is constructed in a manner that at least one server is connected to a plurality of client's computer devices.

10. The method of claim 9, wherein the server is connected to the data source by a network.

11. The method of claim 10, wherein the computer includes a browser for allowing the user to submit the data-reading request so as to monitor the data condition in the server.

12. A system for updating data, comprising:
at least one server;
a plurality of client's computer devices respectively connected to the server by a network; and
a data source connected to the server by a network, for transmitting data to the server;
wherein the server comprises:
a database having a plurality of data fields for storing the data transmitted from the data source therein;
a result table having a plurality of data fields corresponding to those of the database;
a data-updating module for retrieving the data from the data fields of the database and storing the retrieved data in the corresponding data fields of the result table so as to update the data in the result table, when a predetermined data-updating time being reached in operation of the server; and
a data-reading module for receiving a data-reading request from one of the client's computer devices and retrieving the data from the data fields of the result table so as to transmit the retrieved data to the client's computer device, when a predetermined data-reading time point being reached in operation of the client's computer device.

13. A system for updating data, comprising:
at least one server;
a plurality of client's computer devices respectively connected to the server by a network; and
a data source connected to the server by a network, for transmitting data to the server;
wherein the server comprises:
a database having a plurality of data fields for storing the data transmitted from the data source therein;
a result table having a plurality of data fields corresponding to those of the database; and
a data-updating module for retrieving the data from the data fields of the database and storing the retrieved data in the corresponding data fields of the result table so as to update the data in the result table, when a predetermined data-updating time being reached in operation of the server; and for allowing the server to receive a data-reading request from one of the client's computer devices and retrieve the data from the data fields of the result table so as to transmit the retrieved data to the client's computer device, when a predetermined data-reading time point being reached in operation of the client's computer device.

14. The system of claim 12, wherein the computer includes a browser for allowing the user to submit the data-reading request so as to monitor the data condition in the server.

15. The system of claim 13, wherein the computer includes a browser for allowing the user to submit the data-reading request so as to monitor the data condition in the server.

16. The system of claim 12, wherein the server further comprises a timing module for counting time required for the server to store the data in the result table and comparing the counted time with the predetermined data-updating time.

17. The system of claim 13, wherein the server further comprises a timing module for counting time required for the server to store the data in the result table and comparing the counted time with the predetermined data-updating time.

18. The system of claim 12, wherein the client's computer device further comprises a timing module for counting time required for the client's computer device to submit the data-reading request and comparing the counted time with the predetermined data-reading time.

19. The system of claim 13, wherein the client's computer device further comprises a timing module for counting time required for the client's computer device to submit the data-reading request and comparing the counted time with the predetermined data-reading time.
